(19) United States
(12) Patent Application Publication
(10) Pub. No.: US 2008/0282700 A1
(43) Pub. Date: Nov. 20, 2008

(54) Compressed working fluid supply system for an expansion engine

(76) Inventor: Jay Stephen Kaufman, Kingston, NH (US)

Correspondence Address: Lawson & Persson, P.C., P.O. Box 712, Laconia, NH, 03247-0712, US

(21) Appl. No.: 12/218,315

(22) Filed: Jul. 14, 2008

Related U.S. Application Data
(63) Continuation-in-part of application No. 11/124,594, filed on May 9, 2005, now Pat. No. 7,398,841.
(60) Provisional application No. 60/571,640, filed on May 17, 2004.

(51) Int. Cl. B60K 16/00; F25J 1/00

(52) U.S. Cl. 60/641.12; 62/615; 60/641.8; 60/398; 60/414

(57) ABSTRACT

A compressed working fluid supply system including a power source, a liquefier in communication with the power source and a refrigerant, a circulator in communication with the power source and the refrigerant, and a heat sink is in communication with the refrigerant. The heat sink facilitates a transfer of heat from the working fluid to the refrigerant such that the working fluid becomes a cooled working fluid before or during compression. A compressor is in communication with the power source the cooled working fluid and includes an inlet and an outlet that is in communication with a compressed fluid tank.

### REFERENCE TO RELATED APPLICATIONS

This application is a continuation in part of co-pending U.S. patent application Ser. No. 11/124,594, filed on May 9, 2005, which claims the benefit of priority-of Provisional Application Ser. No. 60/571,640, filed May 17, 2004.

### FIELD OF INVENTION

This invention relates to a working fluid supply for expansion engines and, specifically, to working fluid supplies for compressed gas turbine engines.

### BACKGROUND OF THE INVENTION

Fuel costs continue to increase and this rise in fuel costs has spurred significant development of ways to increase the efficiency of motor vehicles and other systems that utilize engines to perform work.

The inventor's co-pending U.S. patent application, Ser. No. 11/124,594, describes a system that recovers and combines components of motor vehicle resistive load, for example combined deceleration, wind and shock resistance, and supplement this energy with solar energy, to drive an expansion engine, such as a gas turbine. This system takes recovered energy to run a cooled compressor and a liquefier in which heat from the working fluid entering the supply compressor is absorbed by vaporizing liquid air. Refrigerant is combined with working fluid for supply to an engine instead of more efficiently absorbing heat of compression and assisting air liquefaction. The present invention uses these concepts and improves upon them by providing a more efficient compressed working fluid supply system.

Thermodynamic power cycles do not generally consider heat sink temperatures below ambient, either by application of recovered resistive load of the cycle or of recovered renewable energy such as solar, wind and off-peak excess. An adequate sub-ambient heat sink liquid supply for motor vehicle highway driving requires recovery of multiple components of resistive load, for example combined deceleration, wind and shock resistance; supplemental solar may be added. For urban driving or for stationary use, only one component, for example solar, wind, or off-peak, may be required.

Examples of the use of heat sinks for liquefaction are found in other patents and publications. However, each of these has significant drawbacks. For example, U.S. Pat. No. 4,227,374 to Oxley describes recovery of off-peak energy and waste heat from a base load engine to drive a liquefier, and use of the liquid air to absorb heat from the working fluid entering the supply compressor of another stationary engine. However, it is inefficient with respect to production of the heat sink liquid and to absorption of working fluid heat. This is due to the fact that the efficiency improves in proportion to the percentage of energy recovered and the recovery of energy from a single source does not result in a large improvement in efficiency.

U.S. Pat. No. 6,920,759 to Wakana, et al., is another example of a prior art supporting application of a refrigerated heat sink. It describes recovery of off-peak energy from a base load stationary engine to drive a liquefier, and use of the liquid air to absorb heat from the working fluid entering the supply compressor of a stationary gas turbine. However, for the same reasons stated above in connection with the Oxley patent, it is also inefficient with respect to production of the heat sink liquid and to absorption of working fluid heat. The inventors pending U.S. patent application, Ser. No. 11/194,822, is another example of prior art supporting application of a refrigerated heat sink. It describes recovery and combination of renewable energy including localized building wind capture and solar to drive a liquefier and absorption of heat from the working fluid entering the supply compressor of a stationary gas turbine by liquid air. However, a vaporized heat sink is combined with the working fluid instead of being reliquefied, resulting in inefficient liquefaction and heat absorption. This is because less energy is required to liquefy air returning from the supply compressor by removal of only latent heat at cryogenic temperatures than to liquefy air from ambient temperatures.

The following published articles and U.S. patents describe single features found in the prior art that relate to a renewable energy or excess energy driven refrigerated heat sink.

Paper SAE-1999-0102932 by Knowlen et al describes sensible heat absorption of pre-compression heat by imported refrigerant in a Rankine engine of a motor vehicle. Atmospheric air, cooled by the pressurized and vaporizing liquid air is vented instead of being economized or reliquefied.

Paper SAE1999-01-2517 by Ordonez et al, describes latent heat absorption of pre-compression heat by imported refrigerant in a Brayton engine of a motor vehicle. The vaporized refrigerant is vented after cooling atmospheric inlet air to a working fluid supply compressor instead of being reliquefied.

U.S. Pat. No. 5,725,062 to Fronek describes solar energy recovery by a solar photo-voltaic panel atop a motor vehicle. Single component energy recovery and electric battery storage are inadequate.

Hakala U.S. Pat. No. 6,138,781 describes wind energy recovery of a motor vehicle with battery storage. Again, single component energy recovery and electric battery storage are inadequate.

Kimura U.S. Pat. No. 1,671,033 describes deceleration energy recovery of a motor vehicle with battery storage. Single component energy recovery and electric battery storage are inadequate.

Hudspeth and Lunsford U.S. Pat. No. 3,688,859 and Goldner et al. U.S. Pat. No. 6,952,060, each describe shock energy recovery of a motor vehicle by pneumatic and by electrical means, respectively. Single component energy recovery and electric battery storage are inadequate.

U.S. Pat. No. 4,455,834 to Earle describes windmill drive for a liquefier of a stationary expansion engine. The liquefier is unworkable, however due to lack of throttling or regenerative heat transfer.

The prior art also describes direct contact working fluid supply compressors, which also relate to a refrigerated heat sink. For example, U.S. Pat. No. 5,680,764 to Viteri describes a low emission motor vehicle or stationary engine burning hydrogen based fuel with oxygen. The oxygen is separated in a cryogenic process with regenerative nitrogen cooling. The water-cooled engine is inefficient due to latent heat loss and ineffective use of the cryogenic nitrogen. This is due to the fact that latent heat of the water coolant is not recoverable because water would freeze during absorption of its latent heat into the working fluid below ambient.

In addition to the limitations of cited prior patents, each of the prior art systems has the following additional disadvantages:

(a) They do not integrate refrigerant liquefaction and absorption of the working fluid heat of compression to minimize liquefier and compressor work.

(b) They do not minimize compression work by absorption of the heat of compression into refrigerant.

(c) They do not maximize the ratio of compressed working fluid to liquid refrigerant.

(d) The scale down of the working fluid supply compressor for distributed generation micro-turbine application is poor in each case.

### SUMMARY

The present invention is a compressed working fluid supply system for an expansion engine and an expansion engine system utilizing such a compressed working fluid supply system.

In its most basic form, the compressed working fluid supply system includes a power source, preferably a resistive energy drive and a solar energy drive, and a liquefier in electrical communication with the power source and in fluid communication with a refrigerant. A circulator is in electrical communication with the power source and in fluid communication with the refrigerant. A heat sink is in communication with the refrigerant. The heat sink is shaped and dimensioned to facilitate a transfer of heat from the working fluid to the refrigerant such that the working fluid becomes a cooled working fluid. At least one compressor is placed in electrical communication with the power source and in fluid communication with the cooled working fluid. The compressor includes a compressor inlet and a compressor outlet that is in fluid communication with the compressed fluid tank.

In operation, the liquefier turns gaseous refrigerant into liquid refrigerant, which is transferred to the heat sink and used to cool the working fluid, which is preferably atmospheric air. This cooling either occurs prior to or concurrently with the compression of the air and the densification of the working fluid as a result of the cooling reduces the amount of work that needs to be performed by the compressor. The compressed working fluid is then fed to the compressed fluid tank, where it is stored for use by the expansion engine.

In some embodiments, the liquefier, circulator and heat sink form a closed refrigerant loop, and at least a portion of the refrigerant is vaporized in the heat sink. In these embodiments, the heat sink is may be a counterflow heat exchanger, an intercooler type heat sink or a heat sink jacket of a jacketed supply compressor.

In some embodiments, the compressor is shock type supply compressor. In others, the compressor is made up of a first supply compressor and a second supply compressor, which may be separate compressors or stages of a single compressor. In such embodiments, the heat sink is an intercooler heat sink disposed between the first supply compressor and the second supply compressor.

In another set of embodiments of he compressed working fluid supply system, the refrigerant and the working fluid are atmospheric air and the liquefier is an air liquefier that converts gaseous atmospheric air into liquid air. In such embodiments, the heat sink is a mixing heat sink that mixes the liquid air refrigerant with the atmospheric air working fluid to form a mixed working fluid. In such embodiments, it is preferred tat the air liquefier include a refrigerant air intake, a compressor in communication with the refrigerant air intake and a heat exchanger in communication with the compressor and a source of cooled air. The heat exchanger is shaped and dimensioned to cool a flow of compressed refrigerant air from the compressor. An expander is placed in communication with the compressed refrigerant air from the heat exchanger. The expander is shaped and dimensioned to convert the compressed refrigerant air from a gas to a liquid. Finally, a liquid separator is in communication with the liquid air from the expander and the circulator.

In some embodiments in which the refrigerant and the working fluid are atmospheric air, the source of cooled air in communication with the heat exchanger includes vaporized air from the liquid separator. In others, the source of cooled air in communication with the heat exchanger also includes mixed working fluid from the mixing heat sink. In still others, the expander is in communication with the compressed refrigerant air from the heat exchanger and compressed working fluid from the compressed fluid tank.

In some embodiments of the compressed working fluid supply system, a recuperator is in communication with the compressed fluid tank and the source of working fluid. The recuperator is preferably shaped and dimensioned to cause heat to be transferred from a flow of the working fluid to a flow of compressed fluid flowing from the compressed fluid tank.

In some embodiments of the compressed working fluid supply system, a rotary regenerator in communication with the compressed fluid tank and the source of working fluid. The rotary regenerator is shaped and dimensioned to cause heat to be transferred from a flow of the working fluid to a flow of compressed fluid flowing from the compressed fluid tank. In such embodiments, it is preferred that the rotary regenerator include an intermittent rotor.

The present invention also encompasses and expansion engine system including the compressed working fluid supply system in accordance with the present invention and an expansion engine that includes a working fluid inlet and a working fluid exhaust.

It is preferred that the expansion engine system including an exhaust condenser in fluid communication with the working fluid inlet and the working fluid exhaust of the expansion engine. The exhaust condenser is preferably shaped and dimensioned such that a sufficient amount of heat is transferred from exhaust working fluid flowing from the working fluid exhaust to intake working fluid flowing from the compressed fluid tank to the working fluid inlet such that the at least a portion of the exhaust working fluid condenses.

In some embodiments of the expansion engine system, the compressed working fluid supply system also includes a heat exchanger disposed between, and in fluid communication with, the compressed fluid tank and the working fluid inlet of the expansion engine. The heat exchanger is in fluid communication with a the source of working fluid and is shaped and dimensioned such that heat is transferred from the working fluid from the source of working fluid to compressed working fluid flowing from the compressed fluid tank to the inlet of the expansion engine.

Other embodiments include both the heat exchanger and exhaust condenser. In such embodiments, the heat exchanger is disposed between, and in fluid communication with, the compressed fluid tank and the exhaust condenser. It is preferred that the heat exchanger is in fluid communication with a the source of working fluid and is shaped and dimensioned such that heat is transferred from the working fluid from the source of working fluid to compressed working fluid flowing from the compressed fluid tank to the exhaust condenser.

Finally, in some embodiments of the expansion engine system, the compressed working fluid supply system also includes a rotary regenerator disposed between, and in fluid communication with, the compressed fluid tank and the exhaust condenser. The rotary regenerator is in fluid communication with a the source of working fluid and is shaped and dimensioned such that heat is transferred from the working fluid from the source of working fluid to compressed working fluid flowing from the compressed fluid tank to the exhaust condenser.

The primary objectives of the present invention are to make both stationary electric generation and driving of motor vehicles more economical, to reduce emission of combustion products, to conserve fossil fuels and to enable use of alternate fuels. Additional objectives are to provide a novel thermodynamic power cycle having working fluid pre-compression and heat of compression absorption features, refrigerant liquefaction features, and other refrigerated component features.

Power cycle features include the following aspects of the invention:

Recovered resistive load of a expansion engine to provide power to compress the engine working fluid. Recovered resistive load to provide power to a recycling liquefier which recycles the vaporized refrigerant to improve liquefier performance. Recovered solar, wind, off-peak grid energy etc. to supplement the recovered resistive load. Combined compression of refrigerated liquid working fluid and compression of atmospheric air cooled by the liquid to supply working fluid to a expansion engine. Absorption of pre-compression and heat of compression of the working fluid by refrigerant to improve compressor performance. Condensation of exhaust vapors by pre-combustion working fluid to enable higher heating value of fuel

Working fluid heat of compression absorption features include the following aspects of the invention: Absorption of working fluid heat of compression by vaporizing refrigerant in cooling jacket surrounding the supply compressor to increase compressor efficiency. Absorption of working fluid heat of compression by pre-mixed working fluid and vaporizing refrigerant, followed by recycling of an equivalent amount of refrigerant from upstream of the supply compressor, to increase compressor efficiency. Absorption of working fluid heat of compression by pre-mixed working fluid and vaporizing refrigerant, followed by recycling of an equivalent amount of refrigerant from downstream of the supply compressor, to increase compressor efficiency. Absorption of working fluid heat of compression by vaporizing refrigerant in supply compressor intercooler to increase compressor efficiency

The refrigerant liquefaction features include the following aspects of the invention: Recuperative liquefaction of atmospheric intake air with wet-expansion and recovery of expansion energy, to make liquid air refrigerant. Assisted recuperative liquefaction of atmospheric intake air in which the vaporized refrigerant combines with liquefier return air and cools intake air, to reduce liquefier pressure and increase liquefier efficiency. Assisted recuperative liquefaction of atmospheric intake air in which the vaporized refrigerant, pressurized by the supply compressor, combines with pressurized liquefier intake air and expands in a bi-phase expander, to reduce liquefier pressure and increase liquefier efficiency. Regenerative reliquefaction of vaporized refrigerant from the supply compressor with absorption of latent heat by surface contact in a reliquefier, to reduce liquefier work.

Other aspects of the invention include: Compression of working fluid by a shock wave type compressor to reduce the number of compressor stages and increase compression efficiency. Transfer of heat between atmospheric air working fluid to the supply compressor and pressurized working fluid from the supply compressor in a rotary regenerator, to increase working fluid to refrigerant ratio. Intermittent operation of the regenerator rotor to extend service life.

These together with other objects, advantages and embodiments, which will become apparent, reside in the details of construction and operation as more fully hereinafter described.

### BRIEF DESCRIPTION OF THE DRAWINGS

FIG. 1 is a schematic illustration showing cooling of compressor intake air working fluid in a heat sink, reliquefaction of vaporized heat sink refrigerant, condensation of engine exhaust vapors by working fluid air, and motor drive by recovered energy.

FIG. 2 is a schematic illustration showing cooling of working fluid air heat of compression by pressure boundary contact in a heat sink, and flow assisted recuperative liquefaction of the vaporized heat sink refrigerant.

FIG. 3 is a schematic illustration showing intercooling of working fluid air heat of compression by pressure boundary contact, and reliquefaction of the vaporized refrigerant.

FIG. 4 is a schematic illustration showing cooling of working fluid air heat of compression by mixing with heat sink air refrigerant, and flow assisted liquefaction of the vaporized refrigerant.

FIG. 5 is a schematic illustration showing cooling of working fluid air heat of compression by mixing with heat sink air refrigerant, and pressure assisted recuperative liquefaction of the vaporized refrigerant.

FIG. 6 is a schematic illustration showing connection of a shock wave type supply compressor.

FIG. 7 is a schematic illustration showing connection of a rotary regenerator.

It is noted that, in the accompanying drawings, solid lines connecting components indicate fluid flow, arrows indicate flow direction, dashed lines indicate electrical connections and wavy lines indicate liquid level.

### DETAILED DESCRIPTION OF THE INVENTION

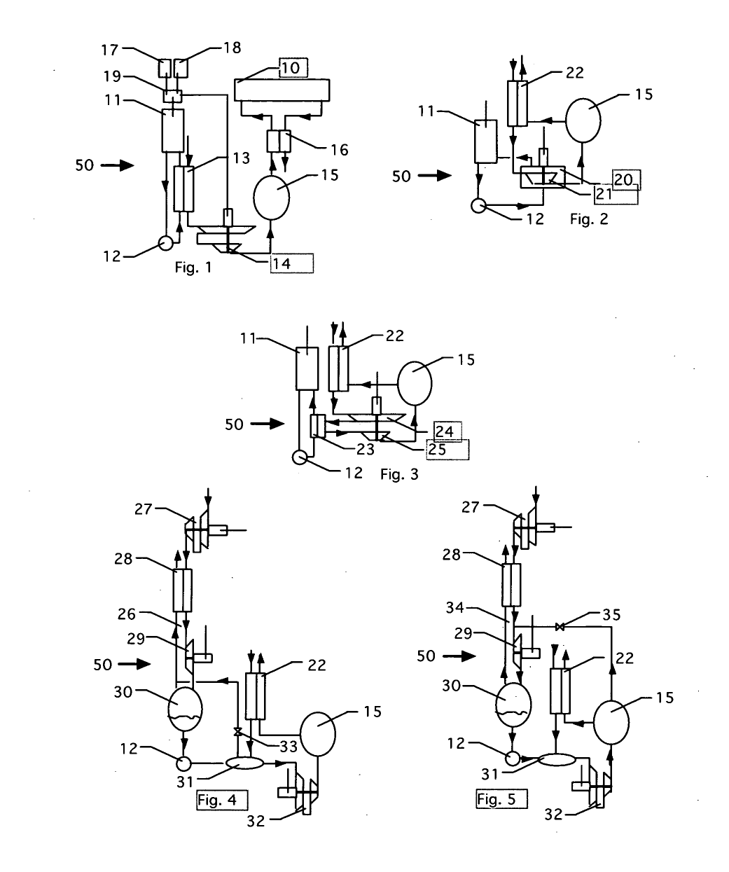

FIG. 1 illustrates a first embodiment of a compressed air working fluid supply system 50 of the present invention for application to an expansion engine 10, preferably a gas turbine or reciprocating expansion engine. The compressed air working fluid supply 50 includes a recycling liquefier 11, a refrigerant circulator 12, a heat sink 12, a supply compressor 12, a compressed fluid tank 15 an exhaust condenser 16 a resistive energy drive 17, a solar energy drive 18 and a controller 19.

The recycling liquefier 11 is a standard refrigerant liquefier that takes in refrigerant in a gaseous state, liquefies it, and provides liquid refrigerant to a refrigerant circulator 12, which pumps the liquid into a pre-compression heat sink 13. In this embodiment, the pre-compression heat sink 13 is a counter flow heat sink in which liquid refrigerant flows through one side of the heat sink 13, cooling the heat sink 13, and intake air is drawn through the other side of the heat sink 13. The intake air gives up heat when it passes through the cold heat sink 13, which causes the temperature of the air to drop and the temperature of the refrigerant to rise such that it vaporized before it is returned to the liquefier 11.

In the embodiment of FIG. 1, the liquefier 11, circulator 12 and the refrigerant side of the heat sink 13 form a closed system. In this system, reliquefaction work input is low as compared to liquefaction of atmospheric air from ambient conditions. The reliquefier uses a formulated refrigerant with variable boiling temperature, which is sealed to maintain a surface for absorption of sensible heat of atmospheric air to a temperature as low 100 K. A figure of merit up to 0.6 is estimated.

After passing through the heat sink 13, the cooled intake air then passes to the supply compressor 14. Because the cooling of the air makes it denser, it is much easier to compress and utilizes significantly less energy to reach its desired pressure than it would to compress an equivalent amount of air at ambient temperature. In fact, the quasi-isentropic design pressure ratio to ambient temperature is twelve with a working fluid to refrigerant mass ratio of 5.6 for a formulated refrigerant, and compression work is sixty percent (60%) as compared to least work with ambient air.

Once compressed by the compressor 14, the compressed air is stored in compressed fluid tank 15 for use as the working fluid for the engine 10. When needed, the air passes through an exhaust condenser 16 and into the intake of the engine 10. The exhaust condenser 16 is also a counterflow heat sink with one side in communication with the air leaving the compressed fluid tank 15 and the other side in communication with the exhaust of the engine 10. Because the exhaust air has a higher temperature than the intake air, the exhaust condenser 16 causes the intake air to absorb heat from exhaust air before being supplied to engine 10. Absorption of the latent heat of the engine exhaust products by the working fluid enables higher heating value of fuel and further contributes to the efficiently of the supply system.

As shown in FIG. 1, the liquefier 11 and supply compressor 14 are powered by resistive energy recovered by a resistive energy drive 17 and by a solar energy drive 18, each of which is adapted to convert the energy into electrical power. This power is combined and regulated by a controller 19. Although these components are omitted from FIGS. 2-7, it is recognized that this power source is preferred in all embodiments. However, some embodiments utilize an electrical generator (not shown), such as a vehicle alternator, to assist or supplant the preferred power sources shown in FIG. 1.

In cases where the engine 10 is a motor vehicle engine, the resistive energy drive 17 may be a deceleration energy drive, a shock compressor drive, a wind energy recovery drive, or a combination of all such drives. Conversely, in cases where the engine 10 is not mounted to a vehicle, such as in factory applications in which the engine 10 is used to run machinery, the resistive energy drive 17 is a wind energy drive.

The deceleration energy drive is preferably an energy recovery transmission for recovery of vehicle deceleration energy by compression of atmospheric air. This compressed air may then be used to turn a turbine, which generates electricity to run the compressors, or may be used in direct compression.

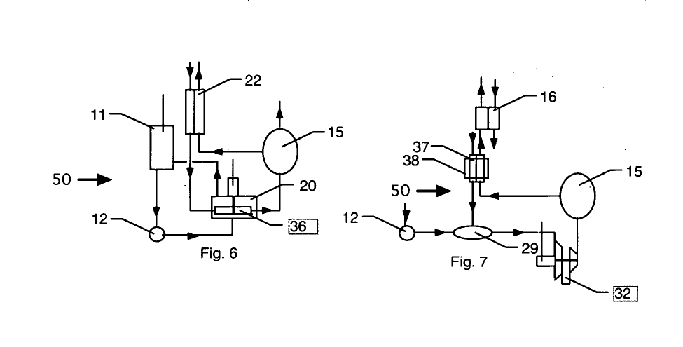

The shock compressor drive converts shock energy into compressive force to compress atmospheric air. An example of the application of such a shock compressor drive is shown in FIG. 6. However, like the deceleration energy drive the shock compressor drive may also compress air to turn a turbine, which generates electricity to run the compressors.

The wind energy recovery drive is preferably a turbine that converts wind energy into either electrical energy to drive a compressor, or into direct mechanical energy to compress air. In vehicle applications, the wind energy recovery drive preferably operates on the difference between wind impact pressure and wake pressure at high suction locations behind an air dam, the windshield/roof intersection, and other leading edges. Vehicle shapes are designed for the best use of recovered wind energy as it effects vehicle cost, carrying capacity and style. However, in non-vehicle applications, the wind energy recovery drive may take the form of a stand-alone windmill or building mounted turbine.

FIG. 2 illustrates a second embodiment of a compressed air working fluid supply 50 of the present invention for application to expansion engine 10. It is noted that FIG. 2-7 omit the expansion engine 10 and focus solely upon the compressed air working fluid supply 50. It should be understood that, although the expansion engine 10 is omitted, the compressed fluid tank 15 in each such embodiment provides compressed air to the expansion engine 10 in the manner shown in FIG. 1.

As was the case with the embodiment of FIG. 1, the liquefier 11 provides liquid refrigerant to circulator 12 from which the refrigerant is pumped. However, rather than passing through the counter flow heat sink 13 of FIG. 1, the refrigerant passes into a heat sink jacket 20 of a jacketed supply compressor 21, absorbs heat such that it vaporizes and passes back to the liquefier 11 to be reliquified. Reliquefaction work input is low as compared to liquefaction of atmospheric air from ambient conditions. The reliquefier uses a sealed refrigerant, which boils at constant temperature to maintain a surface for absorption of sensible heat of atmospheric air. A figure of merit up to 0.6 is estimated.

It is noted that the embodiment of FIG. 6 is similar in all respects to this embodiment except that a jacketed shock type supply compressor 36 replaces the jacketed supply compressor 21. The shock compressor 36 is a new innovation that is specifically adapted for use in motor vehicle applications and converts kinetic shock energy, which would normally be wasted by the vehicle into usable compressed air. Although the embodiment of FIG. 6 shows a jacketed shock type supply compressor 36, it is recognized that the shock compressor need not be jacketed and that a shock type compressor may replace any of the compressors shown herein.

Intake atmospheric air working fluid, chilled in a recuperator 22, passes into the compressor 21, where it is further cooled and compressed. As was the case with the cooling of the air through the heat sink 13 of FIG. 1, low compression work is enabled by dense working fluid due to absorption of its heat of compression by vaporizing refrigerant, which is accomplished in the heat sink jacket 20 of the jacketed supply compressor 21 in this embodiment. Thus, the polytrophic design pressure ratio is up to eight per stage with working fluid to refrigerant mass ratio of 7 if methane is used as a refrigerant, and compression work is 50% as compared to least work at ambient temperature.

The compressed air then passes into the compressed fluid tank 15 from which it passes through the recuperator 22 and on to the expansion engine (not shown). The recuperator 22 is preferably a counterflow heat exchanger. This causes the compressed air to absorb heat from the intake air prior to being supplied to the engine and allows the intake air to be pre-cooled prior to entering the compressor 21.

FIG. 3 illustrates a third embodiment of a compressed air working fluid supply 50 of the present invention. In this embodiment, liquefier 11 provides liquid refrigerant to circulator 12 from which the refrigerant continues to an intercooling heat sink 23 between a first supply compressor 24 and a second supply compressor 25, and back to liquefier 11. Although the first supply compressor 24 and second supply compressor 25 are shown and described as separate compressors, it is noted that they may be combined into a single compressor. In such embodiments, the first supply compressor 24 represents the first supply compressor stage and the second supply compressor 25 represents the second supply compressor stage.

As was the case with the embodiments of FIGS. 1 and 2, reliquefaction work input is low as compared to liquefaction of atmospheric air from ambient conditions. The reliquefier uses sealed refrigerant that boils at constant temperature to maintain a surface for absorption of sensible heat of vaporized refrigerant at the cryogenic saturation temperature. A figure of merit for air of up to 0.6 is estimated.

Intake atmospheric air is pre-cooled in recuperator 22 and continues through first supply compressor 24. The recuperator 22 is a counterflow heat exchanger in which the intake air is pre-cooled by giving off its heat to the compressed air that is passing through the recuperator 22 on its way to the engine (not shown). The pre-cooled intake air then passes into the first supply compressor 24, where it is compressed to a pressure below its final pressure. The partially compressed air then passes into intercooling heat sink 23, which is a counterflow heat exchanger having an air input and an air output. The air is cooled by the refrigerant passing through the refrigerant side of the beat sink 23 and passes on to the second supply compressor 25. The second supply compressor 25 compresses the cooled air to its desired pressure, after which it passes into compressed fluid tank 15 until it is needed the by engine (not shown). In this case, the cooling of the intake air through the intercooling heat sink 23 results in a quasi-isentropic design pressure ratio of four per compressor stage with a working fluid to refrigerant ratio of 8 when the refrigerant is methane. Two stage compression work is 75% as compared to least work at ambient temperature.

As is evident from the various cooling arrangements shown in FIGS. 1-3, there are a number of ways to absorb heat in order to reduce compression work. The compressor of FIG. 1 absorbs pre-compression heat. The compressor of FIG. 2 absorbs compression heat and could reach the least work ideal of isothermal compression given sufficient refrigerant flow. The compressor of FIG. 3 absorbs some compression heat and could reach the least work ideal of isothermal compression with infinite stages of intercooling.

FIGS. 4 and 5 illustrate embodiments of a compressed working fluid supply 50 of the present invention in which the liquefier is not a closed system liquefier utilizing a refrigerant but, rather, is an open system liquefier utilizing liquefied air as a refrigerant.

In the embodiment of FIG. 4 a flow assisted liquefier 26 is provided. This liquefier 26 includes a liquefier compressor 27, which compresses atmospheric air. The compressed air then moves into a liquefier heat exchanger 28, which is a counterflow heat exchanger that has an exhaust air side and an intake air side. The coolant in the exhaust air side cools the compressed air in the intake air side before it passes into a bi-phase turbine-generator 29. The bi-phase turbine-generator 29 expands the cooled compressed air such that it condenses and drops into a separator 30. The separator 30 is an insulated pressure vessel that includes liquid air at it bottom and gaseous air at its top. Liquid air from the bottom of the separator 30 is pumped by circulator 16 into a mixing heat sink 31. The mixing heat sink 31 includes a liquid air input, an atmospheric air input and an exhaust output. Liquid air and atmospheric air are fed into the mixing heat sink 31, where the liquid air vaporizes upon mixing with chilled atmospheric intake air from the recuperator 22. One portion of the mixture is diverted through a flow recycle valve 33 to the exhaust air side of the liquefier heat exchanger 28. Another portion of this mixture continues through a mixture cooled supply compressor 32 and into tank 15 where it is stored until it is needed by the engine (not shown). When needed by the engine, compressed air then passes from the tank 15 and through the recuperator 22, where it absorbs heat from the atmospheric air intake before passing on to the engine.

In this embodiment, low compression work is enabled by dense working fluid due to absorption of its pre-compression and compression heat by a vaporized mixture of working fluid and refrigerant. Quasi-isentropic single stage design pressure ratio is up to 4 with working fluid to refrigerant (air) mass ratio of 3, and compression work is approximately 80% as compared to least work at ambient temperature. Further, low liquefaction work input is enabled by recycled air flow assist. Refrigerant, vaporized while providing pre-compression cooling for the supply compressor, combines with air vapor from the separator to enter the cryogenic intake of the liquefier recuperator. Maximum bi-phase turbine moisture of 20% is assumed and turbine output work is recovered, resulting in a figure of merit of 0.65, which compares to 0.40 for liquefaction from ambient conditions.

FIG. 5 shows another embodiment of a compressed working fluid supply 50 of the present invention utilizing open system liquefier 34 utilizing liquefied air as a refrigerant. In this embodiment, the pressure assisted liquefier 34 includes all of the same components as the liquefier 26 of FIG. 4. However, a portion of the compressed air from the tank is diverted through a pressure recycle valve 35 to the intake of turbine 29, and the remainder absorbs heat in recuperator 22 before being supplied to engine 10.

In this embodiment, low compression work is also enabled by dense working fluid due to absorption of its pre-compression and compression heat by a vaporized mixture of working fluid and refrigerant. Quasi-isentropic design pressure ratio is 15 to match inlet pressure of the bi-phase turbine, working fluid to refrigerant mass ratio is 2, and compression work is 80% as compared to least work at ambient temperature. Low liquefaction work input is enabled by recycle air flow assist at supply compressor discharge pressure. Maximum bi-phase turbine moisture of 20% is assumed and turbine output work is recovered, resulting in liquefier pressure ratio of 15 and figure of merit of 0.75, and compares to 60 and 0.40, respectively for liquefaction from ambient conditions.

FIG. 7 illustrates an embodiment of a working fluid supply 50 of the present invention. This embodiment is similar to the embodiments of FIGS. 4 and 5 insofar it utilizes a mixing heat sink 31. However, the recuperator 22 is replaced by a rotary regenerator 36 with a rotor 37. The rotary regenerator 36 increases heat transfer effectiveness between air entering and exiting the supply compressor. Intermittent operation of the rotor extends regenerator service life.

Accordingly, it can be seen that the compressed air working fluid supply of the present invention has advantages of reduced supply compressor input work due to absorption of working fluid heat of compression by vaporizing refrigerant, and reduced liquefier input work due to recycling of vaporized refrigerant to the liquefier. Additional advantages include improved heat transfer effectiveness and compression efficiency of heat sink and working fluids.

Although the invention is described with reference to atmospheric air, it is understood that other gasses, such as nitrogen or oxygen, may be utilized as the working fluid to achieve similar results.

Although the description above contains many specifics, these should not be construed as limiting the scope of the invention but as merely providing illustrations of some of the presently preferred embodiments of this invention. For example, other liquefier and supply compressor types may be used in conjunction with multiple compressor and expander stages, sub-cooled refrigerant, enhanced heat transfer, combined pre-compression and heat of compression cooling. Thus the scope of the invention should be determined by the appended claims and their legal equivalents, rather than by the examples given.

What is claimed is:

1. A compressed working fluid supply system for an expansion engine comprising:
a power source;
a liquefier in electrical communication with said power source and in fluid communication with a refrigerant;
a circulator in electrical communication with said power source and in fluid communication with said refrigerant;
a source of working fluid;
a heat sink in communication with said refrigerant, wherein said heat sink is shaped and dimensioned to facilitate a transfer of heat from said working fluid to said refrigerant such that said working fluid becomes a cooled working fluid;
at least one compressor in electrical communication with said power source and in fluid communication with said cooled working fluid, wherein said at least one compressor comprises a compressor inlet and a compressor outlet; and
a compressed fluid tank in fluid communication with said compressor outlet.

2. The compressed working fluid supply system as claimed in claim 1 wherein said power source comprises a resistive energy drive and a solar energy drive.

3. The compressed working fluid supply system as claimed in claim 2 wherein said liquefier, said circulator and said heat sink form a closed refrigerant loop, and wherein at least a portion of said refrigerant is vaporized in said heat sink.

4. The compressed working fluid supply system as claimed in claim 3 wherein said heat sink is a counterflow heat exchanger.

5. The compressed working fluid supply system as claimed in claim 3 wherein said compressor is a jacketed supply compressor and wherein said heat sink comprises a heat sink jacket of said jacketed supply compressor.

6. The compressed working fluid supply system as claimed in claim 3 wherein said compressor is shock type supply compressor.

7. The compressed working fluid supply system as claimed in claim 3 wherein said at least one compressor comprises a first supply compressor and a second supply compressor and wherein said heat sink comprises an intercooler heat sink disposed between said first supply compressor and said second supply compressor.

8. The compressed working fluid supply system as claimed in claim 2 wherein said refrigerant and said working fluid are atmospheric air, wherein said liquefier is an air liquefier that converts gaseous atmospheric air into liquid air, and wherein said heat sink is a mixing heat sink that mixes said liquid air refrigerant with said atmospheric air working fluid to form a mixed working fluid.

9. The compressed working fluid supply system as claimed in claim 8 wherein said refrigerant is atmospheric air and said air liquefier comprises;
a refrigerant air intake;
a compressor in communication with said refrigerant air intake;
a heat exchanger in communication with said compressor and a source of cooled air, wherein said heat exchanger is shaped and dimensioned to cool a flow of compressed refrigerant air from said compressor;
an expander in communication with said compressed refrigerant air from said heat exchanger, wherein said expander is shaped and dimensioned to convert said compressed refrigerant air from a gas to a liquid; and
a liquid separator in communication with said liquid air from said expander and said circulator.

10. The compressed working fluid supply system as claimed in claim 9 wherein said source of cooled air in communication with said a heat exchanger comprises vaporized air from said liquid separator.

11. The compressed working fluid supply system as claimed in claim 10 wherein said source of cooled air in communication with said heat exchanger further comprises mixed working fluid from said mixing heat sink.

12. The compressed working fluid supply system as claimed in claim 9 wherein said expander is in communication with said compressed refrigerant air from said heat exchanger and compressed working fluid from said compressed fluid tank.

13. The compressed working fluid supply system as claimed in claim 2 further comprising a recuperator in communication with said compressed fluid tank and said source of working fluid, wherein said recuperator is shaped and dimensioned to cause heat to be transferred from a flow of said working fluid to a flow of compressed fluid flowing from said compressed fluid tank.

14. The compressed working fluid supply system as claimed in claim 13 further comprising a rotary regenerator in communication with said compressed fluid tank and said source of working fluid, wherein said rotary regenerator is shaped and dimensioned to cause heat to be transferred from a flow of said working fluid to a flow of compressed fluid flowing from said compressed fluid tank.

15. The compressed working fluid supply system as claimed in claim 14 wherein said rotary regenerator comprises an intermittent rotor.

16. An expansion engine system comprising:
an expansion engine comprising a working fluid inlet and a working fluid exhaust; and
a compressed working fluid supply system in communication with said working fluid inlet of said expansion engine, said compressed working fluid supply system comprising:
a power source;
a liquefier in electrical communication with said power source and in fluid communication with a refrigerant;
a circulator in electrical communication with said power source and in fluid communication with said refrigerant;
a source of working fluid;
a heat sink in communication with said refrigerant, wherein said heat sink is shaped and dimensioned to facilitate a transfer of heat from said working fluid to said refrigerant such that said working fluid becomes a cooled working fluid;
at least one compressor in electrical communication with said power source and in fluid communication with said cooled working fluid, wherein said at least one compressor comprises a compressor inlet and a compressor outlet; and
a compressed fluid tank in fluid communication with said compressor outlet and said working fluid inlet of said expansion engine.

17. The expansion engine system as claimed in claim 16 further comprising an exhaust condenser in fluid communication with said working fluid inlet and said working fluid exhaust of said expansion engine; wherein said exhaust condenser is shaped and dimensioned such that a sufficient amount of heat is transferred from exhaust working fluid flowing from said working fluid exhaust to intake working fluid flowing from said compressed fluid tank to said working fluid inlet such that said at least a portion of said exhaust working fluid condenses.

18. The expansion engine system as claimed in claim 16 wherein said compressed working fluid supply system further comprises a heat exchanger disposed between, and in fluid communication with, said compressed fluid tank and said working fluid inlet of said expansion engine; wherein said heat exchanger is in fluid communication with a said source of working fluid and is shaped and dimensioned such that heat is transferred from said working fluid from said source of working fluid to compressed working fluid flowing from said compressed fluid tank to said inlet of said expansion engine.

19. The expansion engine system as claimed in claim 17 wherein said compressed working fluid supply system further comprises a heat exchanger disposed between, and in fluid communication with, said compressed fluid tank and said exhaust condenser; wherein said heat exchanger is in fluid communication with a said source of working fluid and is shaped and dimensioned such that heat is transferred from said working fluid from said source of working fluid to compressed working fluid flowing from said compressed fluid tank to said exhaust condenser.

20. The expansion engine system as claimed in claim 17 wherein said compressed working fluid supply system further comprises a rotary regenerator disposed between, and in fluid communication with, said compressed fluid tank and said exhaust condenser; wherein said rotary regenerator is in fluid communication with a said source of working fluid and is shaped and dimensioned such that heat is transferred from said working fluid from said source of working fluid to compressed working fluid flowing from said compressed fluid tank to said exhaust condenser.
